(19) United States
(12) Patent Application Publication
(10) Pub. No.: US 2007/0266402 A1
(43) Pub. Date: Nov. 15, 2007

(54) System, method, and article of manufacture for automatically selecting media content for an entity

(76) Inventors: Andrzej M. Pawlak, Rochester Hills, MI (US); Francis E. Szczublewski, Macomb, MI (US); Laci J. Jalics, Ray, MI (US)

Correspondence Address: DELPHI TECHNOLOGIES, INC., M/C 480-410-202, PO BOX 5052, TROY, MI, 48007, US

(21) Appl. No.: 11/430,357

(22) Filed: May 9, 2006

(51) Int. Cl. H04N 5/445; G06F 7/00; G06F 17/30; G06F 3/00; G06F 13/00

(52) U.S. Cl. 725/46; 707/6; 707/7; 725/45

(57) ABSTRACT

A system, a method, and an article of manufacture for automatically selecting media content for an entity are provided. In particular, the system monitors media content selections of the entity to determine media content preferences and then automatically selects media content for the entity based upon the media content preferences.

### TECHNICAL FIELD

This application relates to a system, a method, and an article of manufacture for automatically selecting media content for an entity.

### BACKGROUND

People have long selected entertainment sources such as specific radio stations television stations, and Internet sites to receive media content. However, there has not been an integrated approach for monitoring a person's selections from a plurality of entertainment sources. Further, there has not been integrated approach for determining a person's media content preferences from the person's media content selections and then automatically selecting future media content based upon the person's past media content selections.

Accordingly, the inventors herein have recognized a need for a system for monitoring an entities media content selections to determine media content preferences and then automatically selecting media content for the entity based upon the media content preferences.

### SUMMARY

A method for automatically selecting media content for an entity in accordance with an exemplary embodiment is provided. The method includes monitoring a plurality of media content selections by the entity from a plurality of media content sources. The method further includes storing a first plurality of records in a first database. Each record of the first plurality of records has media content identifiers associated with one media content selection of the plurality of media content selections. The method further includes determining a first media content identifier indicative of preferred media content associated with the entity, based on the media content identifiers of the first plurality of records. The method further includes monitoring the plurality of media content sources to determine a plurality of media content being broadcast from the plurality of media content sources. The method further includes storing a second plurality of records in a second database. Each record of the second plurality of records has media content identifiers associated with one media content of the plurality of media content. The method further includes automatically selecting a record of the second plurality of records in the second database wherein the selected record has a media content identifier corresponding to the first media content identifier indicative of preferred media content associated with the entity.

A system for automatically selecting media content for an entity in accordance with another exemplary embodiment is provided. The system includes at least one memory device storing first and second databases. The system further includes a microprocessor operably communicating with the at least one memory device. The microprocessor is configured to monitor a plurality of media content selections by the entity from a plurality of media content sources. The microprocessor is further configured to store a first plurality of records in the first database. Each record of the first plurality of records has media content identifiers associated with one media content selection of the plurality of media content selections. The microprocessor is further configured to determine a first media content identifier indicative of preferred media content associated with the entity, based on the media content identifiers of the first plurality of records. The microprocessor is further configured to monitor the plurality of media content sources to determine a plurality of media content being broadcast from the plurality of media content sources. The microprocessor is further configured to store a second plurality of records in the second database utilizing the microprocessor. Each record of the second plurality of records has media content identifiers associated with one media content of the plurality of media content. The microprocessor is further configured to select a record of the second plurality of records in the second database wherein the selected record has a media content identifier corresponding to the first media content identifier indicative of preferred media content associated with the entity.

An article of manufacture in accordance with another exemplary embodiment is provided. The article of manufacture includes a computer storage medium having a computer program encoded therein for automatically selecting media content for an entity. The computer storage medium includes code for monitoring a plurality of media content selections by the entity from a plurality of media content sources. The computer storage medium further includes code for storing a first plurality of records in a first database. Each record of the first plurality of records has media content identifiers associated with one media content selection of the plurality of media content selections. The computer storage medium further includes code for determining a first media content identifier indicative of preferred media content associated with the entity, based on the media content identifiers of the first plurality of records. The computer storage medium further includes code for monitoring the plurality of media content sources to determine a plurality of media content being broadcast from the plurality of media content sources. The computer storage medium further includes code for storing a second plurality of records in a second database, each record of the second plurality of records having media content identifiers associated with one media content of the plurality of media content. The computer storage medium further includes code for selecting a record of the second plurality of records in the second database wherein the selected record has a media content identifier corresponding to the first media content identifier indicative of preferred media content associated with the entity.

### BRIEF DESCRIPTION OF THE DRAWINGS

FIG. 1 is a block diagram of a system for automatically selecting media content for an entity in accordance with the exemplary embodiment;

FIG. 2 is a block diagram of a media content preference database and a media content database utilized by the system of FIG. 1;

FIG. 3 is a more detailed block diagram of the media content database of FIG. 2;

FIG. 4 is an exemplary table that comprises a portion of the media content preference database of FIG. 2;

FIG. 5 is an exemplary table that comprises a portion of the media content database of FIG. 2; and

FIGS. 6-7 are flowcharts of a method for automatically selecting media content for an entity in accordance with another exemplary embodiment.

### DESCRIPTION OF EXEMPLARY EMBODIMENTS

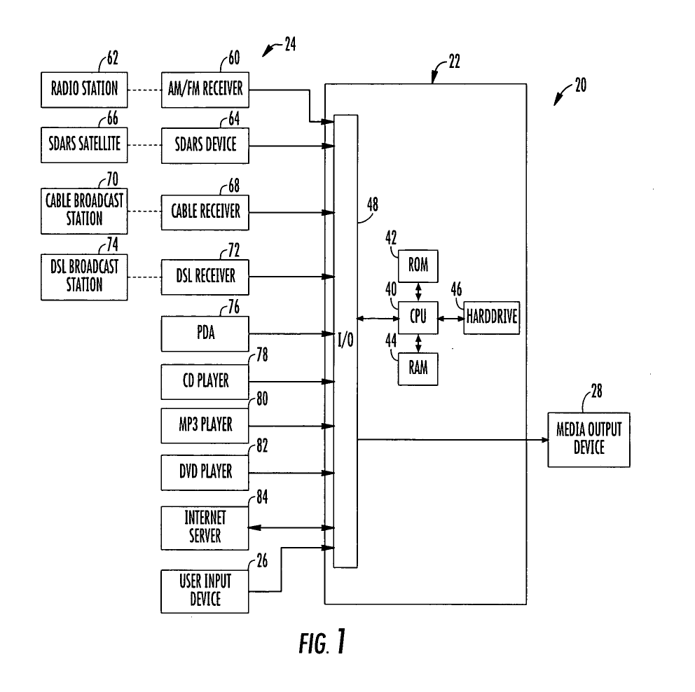

Referring to FIG. 1, a system 20 for automatically selecting media content for an entity is provided. As used herein, the term “entity” refers to a person or a group of people. Further, the term “media content” refers to a least one of audio data, video data, and mixed media data comprising both audio data and video data. The system 20 includes a microprocessor 22, a plurality of media content sources 24, a user input device 26, and a media output device 28.

The microprocessor 22 is provided to monitor a plurality of media content selections by an entity to determine media content preferences associated with the entity. Further, the microprocessor 22 is provided to monitor a plurality of media content sources to determine when the plurality of media content sources are providing or broadcasting media content corresponding to the media content preferences of the entity. Thereafter, the microprocessor 22 automatically selects media content from one of the plurality of media content sources that corresponds to the media content preferences of the entity. In other words, the microprocessor 22 selects media content that the user will most likely be interested in either viewing or listening to, or both. The microprocessor 22 includes a central processing unit (CPU) 40, a read-only memory (ROM) 42, a volatile memory such as a random access memory (RAM) 44, a hard-drive 46, and an input/output (I/O) interface 48. The CPU 40 operably communicates with the ROM 42, the RAM 44, the hard-drive 46, and the I/O interface 48. The computer readable media including ROM 42, RAM 44, and the hard-drive 46 may be implemented using any of a number of known memory devices such as PROMs, EPROMs, EEPROMS, flash memory or any other electric, magnetic, optical or combination memory device capable of storing data, some of which represent executable instructions used by the CPU 40. Further, the CPU 40 receives media content selection data via the I/O interface 44 from the plurality of media content sources 24.

The plurality media content sources 24 comprise audio data sources, video data sources, and mixed media data sources that provide audio data, video data, and mixed media data, respectively, to the entity. In an exemplary embodiment, the plurality of media content sources 24 comprise an AM/FM receiver 60, a satellite digital audio receiver services (SDARS) device, a cable receiver 68, a digital subscriber line (DSL) receiver 72, a personal data assistant (PDA), a compact disc (CD) player 70, an MP3 player 80, a digital video disc (DVD) player, and an Internet server 84.

The SDARS device 64 is provided to receive digital audio radio signals from one or more satellites, such as a SDARS satellite 66. The digital audio radio signals correspond to media content, such as music or news reports, selected by the entity utilizing the SDARS device 64. The SDARS device 64 is further provided to output music or news reports via the media output device 28. The SDARS device 64 is further provided to send data corresponding to media content selections by the entity to the microprocessor 22 via the I/O interface 48.

The AM/FM receiver 60 is provided to receive radio signals from one or more radio stations, such as a radio station 62, selected by the entity utilizing the receiver 60. The AM/FM receiver 60 is further provided to output media content, such as music or news reports, via the media output device 28. The AM/FM receiver 60 is further provided to send data corresponding to media content selections by the entity to the microprocessor 22 via the I/O interface 48.

The cable receiver 68 is provided to receive cable signals from one or more a cable broadcast stations, such as a cable broadcast station 70. The cable signals correspond to media content, such as television shows or news reports, selected by the entity utilizing the cable receiver 68. The cable receiver 68 is further provided to output the television shows or new reports via the media output device 28. The cable receiver 68 is further provided to send data corresponding to media content selections by the entity to the microprocessor 22 via the I/O interface 48.

The DSL receiver 72 is provided to receive DSL signals from one or more a DSL broadcast stations, such as a DSL broadcast station 74. The DSL signals correspond to media content, such as television shows or news reports, selected by the entity utilizing the DSL receiver 72. The DSL receiver 72 is further provided to output the television shows or new reports via the media output device 28. The DSL receiver 72 is further provided to send data corresponding to media content selections by the entity to the microprocessor 22.

The PDA 76 is provided to send data corresponding to media content selections by the entity to the microprocessor 22. The PDA 76 communicates with the microprocessor 22 via the I/O interface 48.

The CD player 78 is provided to send data corresponding to media content selections by the entity to the microprocessor 22. The CD player 78 communicates with the microprocessor 22 via the I/O interface 48.

The DVD player 82 is provided to send data corresponding to media content selections by the entity to the microprocessor 22. The DVD player 82 communicates with the microprocessor 22 via the I/O interface 48.

The Internet server 84 is provided to send data corresponding to media content selections of mixed media data made by the entity utilizing the user input device 26, to the microprocessor 22. The Internet server 84 communicates with the microprocessor 22 via the I/O interface 48.

Referring to FIG. 2, a logical block diagram of the hard-drive 46 is illustrated. In particular the hard-drive 46 logically contains both a media content preference database 100 and a media content database 102.

The media content preference database 100 includes a plurality of records associated with prior media content selections made by an entity. In particular, the media content preference database 100 is populated with data associated with media content selections received by the microprocessor 22 from the plurality of media content sources 24. For example, referring to FIG. 4, the media content preference database 100 can comprise a table 110 having records 112, 114, 116 wherein each of the records is associated with a media content selection previously made by the entity. As shown, each of the records 112, 114, 116 contain the following media content identifiers or fields associated with music selections: (i) date, (ii) time, (iii) title, (iv) artist, (v) genre, (vi) subgenre, (vii) number of seconds played, (viii) volume level, and (ix) volume adjustment level. During operation, the microprocessor 22 can access the table 110 and determine that the entity has a preference for the music genres of rock music and alternative music, for example.

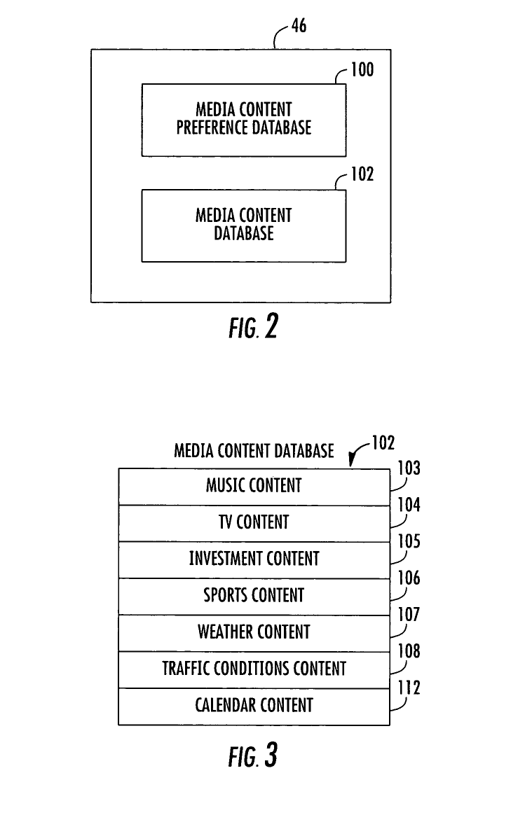

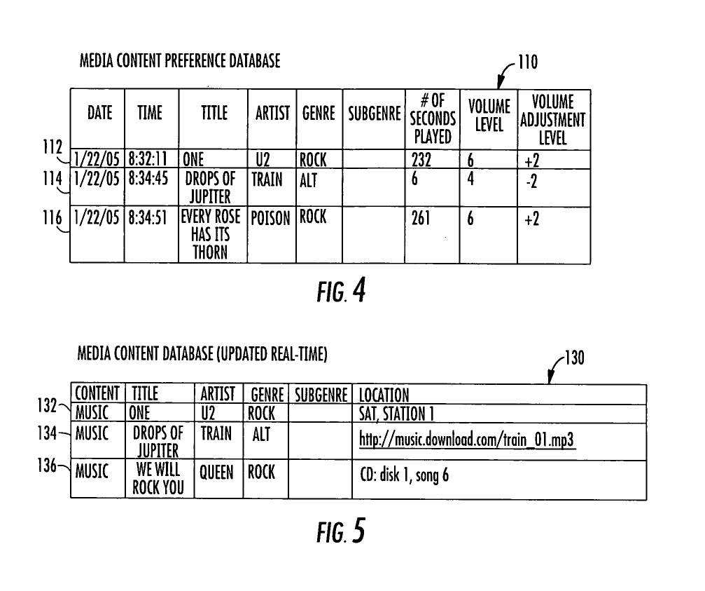

Referring again to FIGS. 2 and 3, the media content database 102 includes a plurality of records associated with media content that is currently available for consumption by the entity. The media content database 102 is populated with real-time data associated with media content data received by the microprocessor 22 from the plurality of media content sources 24. Further, the media content database 102 is logically segmented into a plurality of media content groups for storing information on logically related media content. For example, in one exemplary embodiment, the media content database 102 includes the following media content groups: (i) music content 103, (ii) TV content 104, (iii) investment content 105, (iv) sports content 106, (v) weather content 107, (vi) traffic conditions content 108, and (vii) calendar content 12.

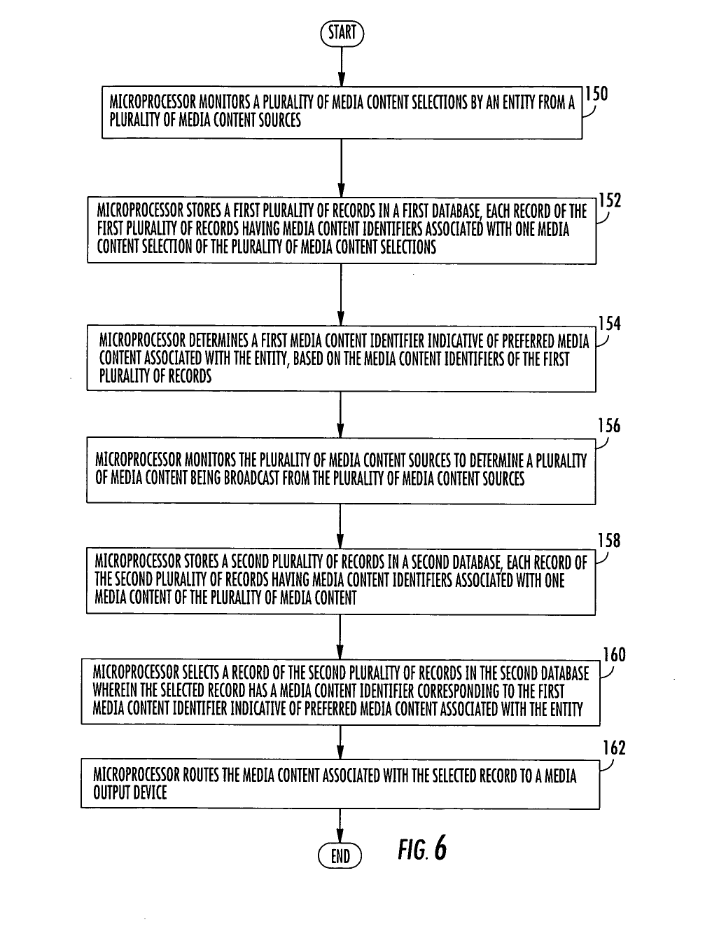

Referring to FIG. 5, in one exemplary embodiment, the music content group 103 comprises a table 130 having records 132, 134, 136 wherein each of the records is associated with music content currently available for consumption by the entity. As shown, each of the records 132, 134, 136 contain the following media content identifiers or fields associated with music content: (i) content type, (ii) title, (iii) artist, (iv) genre, (v) subgenre, (vi) location where music content can be accessed.

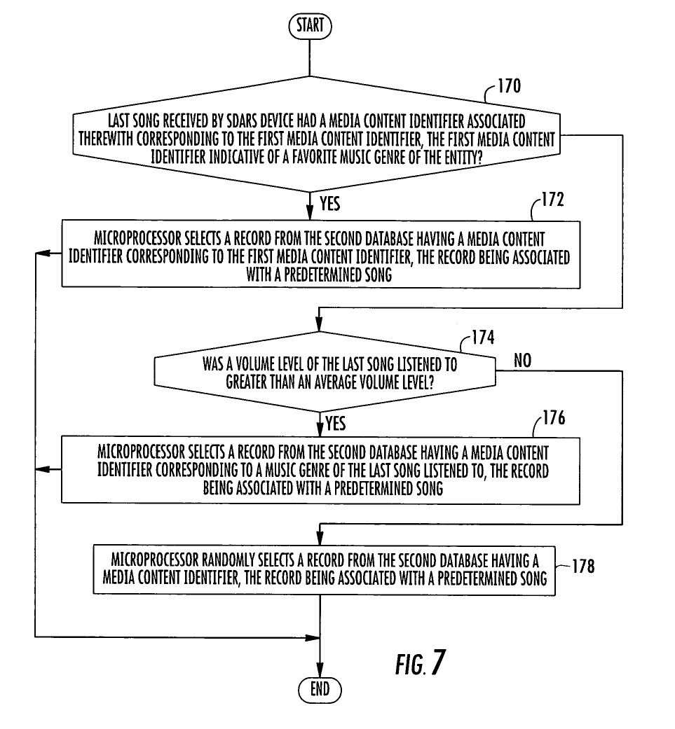

Referring to FIGS. 6-7, a method for automatically selecting the media content for an entity utilizing the system 20 will now be described.

At step 150, the microprocessor 22 monitors a plurality of media content selections by the entity from a plurality of media content sources 24.

At step 152, the microprocessor 22 stores a first plurality of records in the media content preference database 100. Each record of the first plurality of records has media content identifiers associated with one media content selection of the plurality of media content selections.

At step 154, the microprocessor 22 determines a first media content identifier indicative of preferred media content associated with the entity, based on the media content identifiers of the first plurality of records. In particular, the microprocessor 22 can utilize a data mining algorithm to read the database 160 and then find one or more media content identifiers that represented preferred media content. For example, the data mining algorithm can read the table 110 of database 100 and determine the two media content identifiers of “rock” in records 112 and 116 that are indicative of a preferred music genre of rock music by the entity.

At step 156, the microprocessor 22 monitors the plurality of media content sources 24 to determine a plurality of media content being broadcast from the plurality of media content sources 24.

At step 158, the microprocessor 22 stores a second plurality of records in the media content database 102. Each record of the second plurality of records having media content identifiers associated with one media content of the plurality of media content.

At step 160, the microprocessor 22 selects a record of the second plurality of records in the media content database 102 wherein the selected record has a media content identifier corresponding to the first media content identifier indicative of preferred media content associated with the entity.

At step 162, the microprocessor 22 routes the media content associated with the selected record to the media output device 28. After step 162, the method is exited.

Referring to FIG. 7, the step 160 can be implemented in one exemplary embodiment based on data received from a SDARS device, utilizing the steps 170-178.

At step 170, the microprocessor 22 makes a determination as to whether the last song received by SDARS device has a media content identifier associated therewith corresponding to the first media content identifier wherein the first media content identifier is indicative of a favorite music genre of the entity. If the value of step 170 equals “yes”, the method advances to step 172. Otherwise, the method advances to step 174.

At step 172, the microprocessor 22 selects a record from the media content database 102 having a media content identifier corresponding to the first media content identifier, the record being associated with a predetermined song. After step 172, the method is exited.

At step 174, the microprocessor 22 makes a determination as to whether a volume level of the last song listened to by the entity is greater than an average volume level. If the value of step 174 equals “yes”, the method advances to step 176. Otherwise, the method advances to step 178.

At step 176, the microprocessor 22 selects a record from the media content database 102 having a media content identifier corresponding to a music genre of the last song listened to, the record being associated with a predetermined song. After step 176, the method is exited.

At step 178, the microprocessor 22 randomly selects a record from the media content database 102 having a media content identifier, the record being associated with a predetermined song. After step 178, the method is exited.

The system, method, and article of manufacture for automatically selecting media content for an entity provides a substantial advantage over other systems. In particular, the system, method, and article of manufacture provide a technical effect of monitoring media content selections of the entity to determine media content preferences and then automatically selecting media content for the entity based upon the media content preferences.

The method for automatically selecting media content for an entity can be at least partially embodied in the form of computer-implemented processes and apparatuses for practicing those processes. In the exemplary embodiments, the method is embodied in computer program code executed by one or more microprocessors. The present method may be embodied in the form of computer program code containing instructions embodied in one or more computer-readable mediums such as floppy diskettes, CD-ROMs, hard drives, flash memory, or the like, wherein, when the computer program code is loaded into and executed by a microprocessor, the microprocessor becomes an apparatus for practicing the invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for automatically selecting media content for an entity, comprising:
monitoring a plurality of media content selections by the entity from a plurality of media content sources;
storing a first plurality of records in a first database, each record of the first plurality of records having media content identifiers associated with one media content selection of the plurality of media content selections;
determining a first media content identifier indicative of preferred media content associated with the entity, based on the media content identifiers of the first plurality of records;
monitoring the plurality of media content sources to determine a plurality of media content being broadcast from the plurality of media content sources;
storing a second plurality of records in a second database, each record of the second plurality of records having media content identifiers associated with one media content of the plurality of media content; and
automatically selecting a record of the second plurality of records in the second database wherein the selected record has a media content identifier corresponding to the first media content identifier indicative of preferred media content associated with the entity.

2. The method of claim 1, further comprising outputting the media content associated with the selected record utilizing a media output device.

3. The method of claim 1, wherein the plurality of media content sources comprise at least one of a plurality of audio data sources, a plurality of video data sources, a plurality of mixed media data sources.

4. The method of claim 1, wherein the plurality of media content selections comprise at least one of a plurality of audio data selections, a plurality of video data selections, and a plurality of mixed media data selections.

5. The method of claim 1, wherein the plurality of media content comprises at least one of a plurality of audio data, a plurality of video data, and a plurality of mixed media data.

6. The method of claim 1, wherein the media content identifiers comprise at least genre identifiers.

7. A system for automatically selecting media content for an entity, comprising:
at least one memory device storing first and second databases; and
a microprocessor operably communicating with the at least one memory device, the microprocessor configured to monitor a plurality of media content selections by the entity from a plurality of media content sources, the microprocessor further configured to store a first plurality of records in the first database, each record of the first plurality of records having media content identifiers associated with one media content selection of the plurality of media content selections, the microprocessor further configured to determine a first media content identifier indicative of preferred media content associated with the entity, based on the media content identifiers of the first plurality of records, the microprocessor further configured to monitor the plurality of media content sources to determine a plurality of media content being broadcast from the plurality of media content sources, the microprocessor further configured to store a second plurality of records in the second database utilizing the microprocessor, each record of the second plurality of records having media content identifiers associated with one media content of the plurality of media content, the microprocessor further configured to select a record of the second plurality of records in the second database wherein the selected record has a media content identifier corresponding to the first media content identifier indicative of preferred media content associated with the entity.

8. The system of claim 7, wherein the microprocessor is further configured to output the media content associated with the selected record to a media output device.

9. The system of claim 7, wherein the plurality of media content sources comprise at least one of a plurality of audio data sources, a plurality of video data sources, a plurality of mixed media data sources.

10. The system of claim 7, wherein the plurality of media content selections comprise at least one of a plurality of audio data selections, a plurality of video data selections, and a plurality of mixed media data selections.

11. The system of claim 7, wherein the plurality of media content comprises at least one of a plurality of audio data, a plurality of video data, and a plurality of mixed media data.

12. The system of claim 7, wherein the media content identifiers comprise at least genre identifiers.

13. An article of manufacture, comprising:
a computer storage medium having a computer program encoded therein for automatically selecting media content for an entity, the computer storage medium comprising:
code for monitoring a plurality of media content selections by the entity from a plurality of media content sources;
code for storing a first plurality of records in a first database, each record of the first plurality of records having media content identifiers associated with one media content selection of the plurality of media content selections;
code for determining a first media content identifier indicative of preferred media content associated with the entity, based on the media content identifiers of the first plurality of records;
code for monitoring the plurality of media content sources to determine a plurality of media content being broadcast from the plurality of media content sources;
code for storing a second plurality of records in a second database, each record of the second plurality of records having media content identifiers associated with one media content of the plurality of media content; and
code for selecting a record of the second plurality of records in the second database wherein the selected record has a media content identifier corresponding to the first media content identifier indicative of preferred media content associated with the entity.

14. The article of manufacture of claim 13, wherein the plurality of media content sources comprise at least one of a plurality of audio data sources, a plurality of video data sources, a plurality of mixed media data sources.

15. The article of manufacture of claim 13, wherein the plurality of media content selections comprise at least one of a plurality of audio data selections, a plurality of video data selections, and a plurality of mixed media data selections.

16. The article of manufacture of claim 13, wherein the plurality of media content comprises at least one of a plurality of audio data, a plurality of video data, and a plurality of mixed media data.

17. The article of manufacture of claim 13, wherein the media content identifiers comprise at least genre identifiers.
